(19) United States
(12) Patent Application Publication
(10) Pub. No.: US 2007/0105040 A1
(43) Pub. Date: May 10, 2007

(54) Developable undercoating composition for thick photoresist layers

(76) Inventors: Medhat A. Toukhy, Flemington, NJ (US); Joseph E. Oberlander, Phillipsburg, NJ (US); Salem Mullen, Hackettstown, NJ (US)

Correspondence Address: SANGYA JAIN;AZ ELECTRONIC MATERIALS USA CORP., 70 MEISTER AVENUE, SOMERVILLE, NJ, 08876, US

(21) Appl. No.: 11/271,775

(22) Filed: Nov. 10, 2005

(51) Int. Cl. G03C 1/00

(52) U.S. Cl. 430/270.1

(57) ABSTRACT

The present invention relates to an undercoating composition for a photoresist comprising a polymer which is insoluble in an aqueous alkali developer but becomes soluble prior to development, and a photoacid generator which produces a strong acid upon exposure to radiation, and further where the polymer is transparent at the exposure radiation. The invention also relates to a process for imaging the undercoating composition.

### FIELD OF INVENTION

The present invention relates to a developable undercoating composition which is used to form a layer between a substrate and a layer of photoresist, where the developable undercoating comprises a polymer which is essentially alkali insoluble in an aqueous alkali developer but becomes soluble prior to development. The undercoating composition comprises a polymer which is essentially insoluble in an aqueous alkaline developer and is derived from an alkali soluble polymer capped with an acid labile group, and a photoactive compound capable of generating a strong acid. The invention further provides for a process for coating and imaging the undercoating and the photoresist.

### BRIEF DESCRIPTION OF THE DRAWINGS

FIGS. 1(a) and 1(b) illustrate examples of photoactive compounds.

FIG. 2 shows suitable ammonium bases.

### SUMMARY OF THE INVENTION

The present invention relates to an undercoating composition for a photoresist comprising a polymer which is insoluble in an aqueous alkali developer but becomes soluble prior to development, and a photoacid generator which produces a strong acid upon exposure to radiation, and further where the polymer is transparent at the exposure radiation. The invention also relates to a process for imaging the undercoating composition.

### DESCRIPTION OF THE INVENTION

Photoresist compositions are used in microlithography processes for making miniaturized electronic components such as in the fabrication of computer chips and integrated circuits. Generally, in these processes, a coating of film of a photoresist composition is first applied to a substrate material, such as silicon wafers used for making integrated circuits. The coated substrate is then baked to evaporate any solvent in the photoresist composition. The baked coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed or the unexposed areas of the coated surface of the substrate.

When positive-working photoresist compositions are exposed image-wise to radiation, those areas of the photoresist composition exposed to the radiation become more soluble to the developer solution while those areas not exposed remain relatively insoluble to the developer solution. Thus, treatment of an exposed positive-working photoresist with the developer causes removal of the exposed areas of the coating and the creation of a positive image in the photoresist coating. A desired portion of the underlying substrate surface is uncovered.

After this development step, the now partially unprotected substrate may be treated with a substrate-etchant solution, plasma gases, or have metal or metal composites deposited in the spaces of the substrate where the photoresist coating was removed during development. The areas of the substrate where the photoresist coating still remains are protected. Later, the remaining areas of the photoresist coating may be removed during a stripping operation, leaving a patterned substrate surface. In some instances, it is desirable to heat treat the remaining photoresist layer, after the development step and before the etching step, to increase its adhesion to the underlying substrate.

In the manufacture of patterned structures, such as wafer level packaging, electrochemical deposition of electrical interconnects has been used as the density of the interconnects increases. Gold bumps, copper posts and copper wires for redistribution in wafer level packaging require a photoresist mold that is later electroplated to form the final metal structures in advanced interconnect technologies. The photoresist layers are very thick compared to the photoresists used in the integrated circuit manufacturing of critical layers. Both feature size and photoresist thickness is typically in the range of 2 μm to 200 μm, so that high aspect ratios (photoresist thickness/line size) have to be patterned in the photoresist. In some photoresist applications, essentially vertical photoresist profiles and clean photoresist images are desirable.

Devices manufactured for use as microelectromechanical machines also use very thick photoresist films to define the components of the machine.

Positive-acting photoresists comprising novolak resins and quinone-diazide compounds as photoactive compounds are well known in the art. Novolak resins are typically produced by condensing formaldehyde and one or more multi-substituted phenols, in the presence of an acid catalyst, such as oxalic acid. Photoactive compounds are generally obtained by reacting multihydroxyphenolic compounds with naphthoquinone diazide acids, naphthoquinone diazide sulfonyl chloride or their derivatives. Novolaks may also be reacted with quinone diazides and combined with a polymer. It has been found that photoresists based on only novolak/diazide may not always have the photosensitivity or the steepness of sidewalls necessary for certain type of processes, especially for very thick films.

It has been found that a chemically amplified photoresist is very useful for imaging films as thick as 200 microns, and provides good lithographic properties, particularly photosensitivity or photospeed, high aspect ratio, vertical sidewalls, improved adhesion on metal and silicon substrates, compatibility with electroplating solutions and process, reduced resist film cracking and improved environmental stability. Chemically amplified photoresists are typically based on a protected polymer and a photoacid generator. However, when these chemically amplified photoresists are used under certain circumstances, especially when imaged over substrates with metal, especially copper surface, some amount of scumming and residue at the foot of the photoresist is found. The inventors of the present invention have found that if a thin undercoating, which is capable of being imaged and developed in an alkali developer, is used between the substrate and the thick photoresist coating, a clean lithographic photoresist image is obtained. A type of developable antireflective coating is described in the U.S. patent U.S. Pat. No. 6,844,131 and U.S. patent application with Ser. No. 10/042,878 filed Jan. 9, 2002 and Ser. No. 10/322,239 filed Dec. 18, 2002.

The present invention relates to a developable undercoating composition which is used to form a coating beneath a photoresist layer, where the undercoating composition comprises a polymer which is insoluble in an aqueous alkali developer but becomes soluble prior to development, and a photoacid generator which produces a strong acid upon irradiation. The undercoating composition is useful for forming layers where the polymer of the undercoating layer is transparent at the exposure wavelength(s) for the photoresist. Thus the undercoating layer does not have a nonbleachable component. The invention further relates to a process of forming a layer of the undercoating composition beneath the photoresist and forming a pattern in the photoresist and undercoating layers. The composition and process is particularly useful for imaging photoresist films greater than 2 microns, especially below 200 microns. The photoresist and the undercoating layers can be imaged with radiation ranging from about 440 nm to about 150 nm.

The undercoating composition comprises a polymer and a photoacid generator which produces a strong acid upon exposure to radiation. The polymer of the undercoating layer (undercoating polymer) is essentially insoluble in an aqueous alkaline developer used to develop the photoresist, but in the presence of a strong acid becomes soluble in the aqueous alkaline developer prior to development. The undercoating polymer is also essentially insoluble in the coating solvent of the photoresist, and therefore has different solubility properties from the polymer of the chemically amplified photoresist. Typically, the polymer of the undercoating is different from the polymer of the photoresist.

Typically the undercoating polymer is an aqueous alkali soluble polymer which is protected by an acid labile group. Thin films of the undercoating layer are sufficient to protect the photoresist layer from coming in direct contact with the substrate, especially with metallic surfaces like copper. The undercoating layer need not have a chromophore to absorb reflected exposure radiation used to expose the photoresist, but the undercoating layer provides a separation between the substrate and the photoresist. Thus there is no requirement that a chromophore is present in the undercoating layer, and as such relatively thin undercoating layers can be used. The undercoating film can range from about 5 nanometers (nm) (50 Angstroms) to about 1 micron. In one case the undercoating film can be less than 600 nm. In one case undercoating film can be less than 300 nm. In one case the undercoating film can be less than 25 nm (250 Angstroms). In one case the film can be greater than 5 nm.

The undercoating polymer of the novel invention comprises at least one unit with an acid labile group. The type of undercoating polymer chosen is one which is essentially insoluble in the solvent of the photoresist. One function of the polymer is to provide a good coating quality and another is to enable the undercoating to change solubility from exposure to development. The acid labile groups in the polymer provide the necessary solubility change. The polymer without the acid labile group is soluble in an aqueous alkaline solution, but when protected with an acid labile group becomes insoluble. The alkali-soluble polymer can be made from at least one monomer, such as a vinyl monomer. The polymer or the monomer contains a hydrophilic functionality, such as a moiety with an acidic proton. Examples of such monomers are acrylic acid, methacrylic acid, vinyl alcohol, hydroxystyrenes, vinyl monomers containing 1,1′2,2′,3,3′-hexafluoro-2-propanol, although any group that makes the polymer alkali soluble may be used. The hydrophilic functionalities can be protected with one or more acid labile groups and provide groups such as —(CO)O—R, —O—R, —O(CO)O—R, —C(CF₃)₂O—R, —C(CF₃)₂O(CO)O—R, —C(CF₃)₂(COOR), —O—CH₂—(CH₃)—OR, —O—(CH₂)₂—OR, —C(CF₃)₂—O—CH₂(CH₃)(OR), —C(CF₃)—O—(CH₂)₂—OR, —O—CH₂(CO)—OR and —C(CF₃)—OC(CH₃)(CO)—OR, where R is alkyl, substituted alkyl (such as tertiary alkyl), cycloalkyl, substituted cycloalkyl, oxocyclohexyl, cyclic lactone, benzyl, silyl, alkyl silyl, substituted benzyl, alkoxy alkyl such as ethoxy ethyl or methoxy ethoxy ethyl, acetoxyalkoxy alkyl such as acetoxy ethoxy ethyl, tetrahydrofuranyl, menthyl, tetrahydropyranyl and mevalonic lactone. Examples of groups for R are t-butoxycarbonyl tricyclo(5.3.2.0) decanyl, 2-methyl-2-adamantyl, isobornyl, norbornyl, adamantyloxyethoxy ethyl, menthyl, tertiary butyl, tetrahydropyranyl and 3-oxocyclohexyl. R can be tert-butyl, 3-hydroxy-1-adamantyl, 2-methyl-2-adamantyl, beta-(gamma-butyrolactonyl), or mevalonic lactone. Some of the possible monomers for making the polymer are vinyl compounds with the above mentioned labile groups. It is within the scope of this invention that any acid labile group that can be cleaved with an acid may be attached to the polymer, which in the presence of an acid gives an alkali soluble polymer. The undercoating polymer comprises at least one unit with the protected acid labile group, although the undercoating polymer may comprise more than one type of acid labile unit. The undercoating polymer may comprise unit(s) containing acid labile group and may also comprise units without acid labile groups. The monomers protected with an acid labile group may be polymerized to give homopolymers or with other unprotected monomers as required. Alternatively, an alkali soluble homopolymer or copolymer may be reacted with a compound, or compounds, which provide the acid labile group. Techniques known in the art may be used to provide the acid labile group. Typically, the polymer or monomer containing the hydrophilic functionality is reacted with a compound containing the acid labile group.

Examples of monomers containing acid labile groups that can be used in the polymers are, without limitation, methacrylate ester of methyladamantane, methacrylate ester of mevalonic lactone, 3-hydroxy-1-adamantyl methacrylate, methacrylate ester of beta-hydroxy-gamma-butyrolactone, t-butyl norbornyl carboxylate, t-butyl methyl adamantyl methacryate, methyl adamantyl acrylate, t-butyl acrylate and t-butyl methacrylate; t-butoxy carbonyl oxy vinyl benzene, benzyl oxy carbonyl oxy vinyl benzene; ethoxy ethyl oxy vinyl benzene; trimethyl silyl ether of vinyl phenol, 2-tris(trimethylsilyl)silyl ethyl ester of methyl methacrylate and the like.

In the above definitions and throughout the present specification, unless otherwise stated the terms used are described below.

Alkyl means linear or branched alkyl having the desirable number of carbon atoms and valence. The alkyl group is generally aliphatic and may be cyclic or acyclic (i.e. noncyclic). Suitable acyclic groups can be methyl, ethyl, n-or iso-propyl, n-,iso, or tert-butyl, linear or branched pentyl, hexyl, heptyl, octyl, decyl, dodecyl, tertradecyl and hexadecyl. Unless otherwise stated, alkyl refers to 1-10 carbon atom moeity. The cyclic alkyl groups may be mono cyclic or polycyclic. Suitable example of mono-cyclic alkyl groups include substituted cyclopentyl, cyclohexyl, and cycloheptyl groups. The substituents may be any of the acyclic alkyl groups described herein.

Suitable bicyclic alkyl groups include substituted bicycle[2.2.1]heptane, bicycle[2.2.2]octane, bicycle[3.2.1]octane, bicycle[3.2.2]nonane, and bicycle[3.3.2]decane, and the like. Examples of tricyclic alkyl groups include tricycle[5.4.0.0.^{2,9}]undecane, tricycle[4.2.1.2.^{7,9}]undecane, tricycle[5.3.2.0.^{4,}9]dodecane, and tricycle[5.2.1.0.^{2,6}]decane. As mentioned herein the cyclic alkyl groups may have any of the acyclic alkyl groups as substituents.

Alkylene groups are divalent alkyl groups derived from any of the alkyl groups mentioned hereinabove. Accordingly, a divalent acyclic group may be methylene, 1,1- or 1,2-ethylene, 1,1-, 1,2-, or 1,3 propylene and so on. Similarly, a divalent cyclic alkyl group may be 1,2- or 1,3-cyclopentylene, 1,2-, 1,3-, or 1,4-cyclohexylene, and the like. A divalent tricyclo alkyl groups may be any of the tricyclic alkyl groups mentioned herein above. A particularly useful tricyclic alkyl group in this invention is 4,8-bis(methylene)-tricyclo[5.2.1.0.^{2,6}]decane.

Aryl groups contain 6 to 24 carbon atoms including phenyl, tolyl, xylyl, naphthyl, anthracyl, biphenyls, bis-phenyls, tris-phenyls and the like. These aryl groups may further be substituted with any of the appropriate substituents e.g. alkyl, alkoxy or aryl groups mentioned hereinabove. Similarly, appropriate polyvalent aryl groups as desired may be used in this invention. Representative examples of divalent aryl groups include phenylenes, xylylenes, naphthylenes, biphenylenes, and the like.

Alkoxy means straight or branched chain alkoxy having 1 to 10 carbon atoms, and includes, for example, methoxy, ethoxy, n-propoxy, isopropoxy, n-butoxy, isobutoxy, tert-butoxy, pentyloxy, hexyloxy, heptyloxy, octyloxy, nonanyloxy, decanyloxy, 4-methylhexyloxy, 2-propylheptyloxy, and 2-ethyloctyloxy.

Aralkyl means aryl groups with attached substituents. The substituents may be any such as alkyl, alkoxy, acyl, etc. Examples of monovalent aralkyl having 7 to 24 carbon atoms include phenylmethyl, phenylethyl, diphenylmethyl, 1,1- or 1,2-diphenylethyl, 1,1-, 1,2-, 2,2-, or 1,3-diphenylpropyl, and the like. Appropriate combinations of substituted aralkyl groups as described herein having desirable valence may be used as a polyvalent aralkyl group.

Furthermore, and as used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. Illustrative substituents include, for example, those described hereinabove. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Other than the unit containing the acid labile group the polymer may contain at least one other monomeric unit derived from unsaturated monomers, although more than one comonomeric unit may be present in the polymer; such units may provide other desirable properties. Examples of the comonomeric unit are —CR₁R₂—CR₃R₄—, where R₁ to R₄ are independently H, (C₁-C₁₀) alkyl, (C₁-C₁₀) alkoxy, nitro, halide, cyano, aralkyl, alkylene, dicyanovinyl, SO₂CF₃, COOZ, SO₃Z, COZ, OZ, NZ₂, SZ, SO₂Z, NHCOZ, SO₂NZ₂, where Z is H, or (C₁-C₁₀) alkyl, hydroxy (C₁-C₁₀) alkyl, (C₁-C₁₀) alkylOCOCH₂COCH₃, or R₂ and R₄ combine to form a cyclic group such as anhydride, pyridine, or pyrollidone, or R₁ to R₃ are independently H, (C₁-C₁₀) alkyl, (C₁-C₁₀) alkoxy and R₄ is a hydrophilic group. Examples of the hydrophilic group, are given here but are not limited to these: O(CH₂)₂OH, O(CH₂)₂O(CH₂)OH, (CH₂)ₙOH (where n=0-4), COO(C₁-C₄) alkyl, COOX and SO₃X (where X is H, ammonium, alkyl ammonium). Other hydrophilic vinyl monomers that can be used to form the polymer are acrylic acid, methacrylic acid, vinyl alcohol, maleic anhydride, maleic acid, maleimide, N-methyl maleimide, N-hydroxymethyl acrylamide and N-vinyl pyrrolidinone. Other comonomers may be methyl methacrylate, butyl methacrylate, hydroxyethyl methacrylate, benzyl methacrylate and hydroxypropyl methacrylate. The polymer can contain units derived from comonomers such as hydroxystyrene, styrene, acetoxystyrene, benzyl methacrylate, N-methyl maleimide, vinyl benzoate, vinyl 4-tert-butylbenzoate, ethylene glycol phenyl ether acrylate, phenoxypropyl acrylate, 2-hydroxy-3-phenoxypropyl acrylate, phenyl methacrylate, benzyl methacrylate, N-(3-hydroxy)phenyl methacrylamide, and N-(2,4-dinitrophenylaminophenyl)maleimide.

The choice and ratios of monomeric unit(s) of the undercoating polymer are such that they provide the necessary characteristics. The monomeric units derived from the following monomers may be used as homopolymers or comonomers. As an example, a polymer comprising methacrylic ester of mevaloniclacetone (MLMA) and benzylmethacrylate may be used. The mole % of MLMA can range from about 100 mole % to about 60 mole %.

The polymers of this invention may be synthesized using any known method of polymerization, such as ring-opening metathesis, free-radical polymerization, condensation polymerization, using metal organic catalysts, or anionic or cationic copolymerization techniques. The polymer may be synthesized using solution, emulsion, bulk, suspension polymerization, or the like. The polymers of this invention are polymerized to give a polymer with a weight average molecular weight from about 1,000 to about 1,000,000, from about 2,000 to about 80,000, and from about 6,000 to about 50,000. When the weight average molecular weight is below 1,000, then good film forming properties are not obtained for the antireflective coating and when the weight average molecular weight is too high, then properties such as solubility, storage stability and the like may be compromised. The polydispersity(Mw/Mn) of the free-radical polymers, where Mw is the weight average molecular weight and Mn is the number average molecular weight, can range from 1.0 to 10.0, where the molecular weights of the polymer may be determined by gel permeation chromatography.

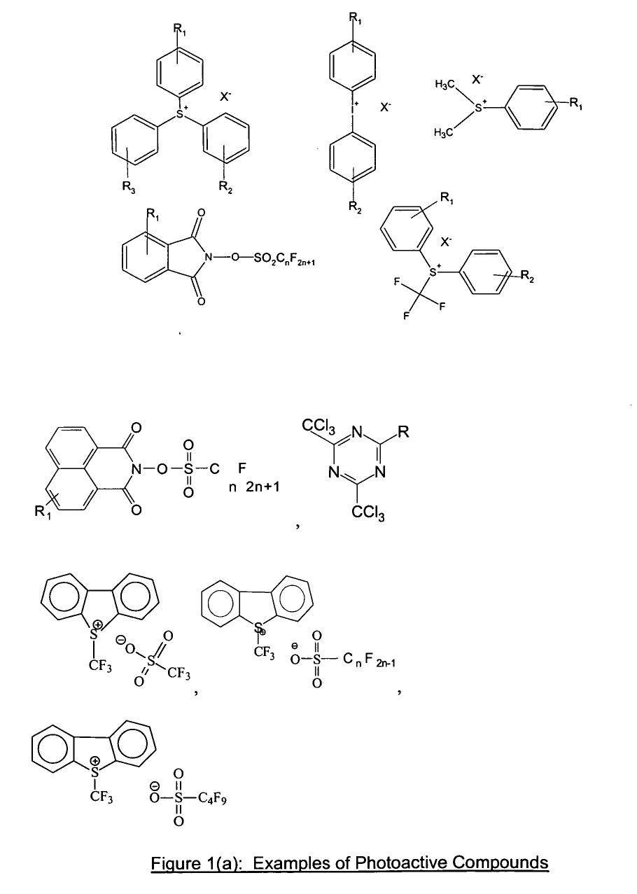

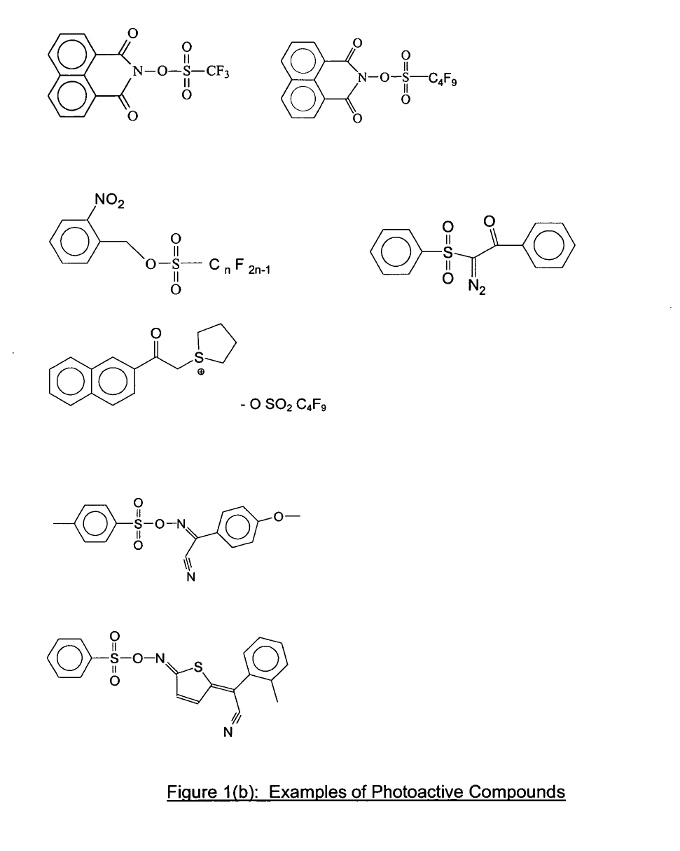

The undercoating composition comprises a polymer and a photoacid generator. Although any photoactive compound may be used in the photoresist, commonly a compound capable of producing a strong acid upon irradiation, a photoacid generator (PAG), of the novel composition is selected from those which absorb at the desired exposure wavelength. As an example, the undercoating may comprise a photoacid generator that produces a strong acid when exposed with radiation of 365 nm or broadband ultraviolet radiation. The photogenerated acid deprotects the alkali insoluble polymer of the undercoating layer to give a polymer which is now soluble in the alkaline developer in the exposed regions. Any PAG may be used which generates a strong acid, particulary a sulfonic acid. Suitable examples of acid generating photosensitive compounds include, without limitation, ionic photoacid generators (PAG), such as diazonium salts, iodonium salts and sulfonium salts; and non-ionic PAGs such as diazosulfonyl compounds, sulfonyloxy imides, nitrobenzyl sulfonate esters, and imidosulfonates, although any photosensitive compound that produces an acid upon irradiation may be used. The onium salts are usually used in a form soluble in organic solvents, mostly as iodonium or sulfonium salts, examples of which are diphenyliodonium trifluoromethane sulfonate, diphenyliodonium nonafluorobutane sulfonate, triphenylsulfonium trifluromethane sulfonate, triphenylsulfonium nonafluorobutane sulfonate and the like. Other useful onium salts such as those disclosed in U.S. patent applications with Ser. No. 10/439,472—filed May 16, 2003, Ser. No. 10/609,735—filed Jun. 30, 2003, Ser. No. 10/439,753—filed May 16, 2003, and Ser. No. 10/863,042—filed Jun. 8, 2004, and are incorporated herein by reference. Other compounds that form an acid upon irradiation that may be used are triazines, oxazoles, oxadiazoles, thiazoles, substituted 2-pyrones. PAGS such as those described in US application US2002/0061464 are also useful. Phenolic sulfonic esters, trichloromethyltriazines, bis-sulfonylmethanes, bis-sulfonylmethanes or bis-sulfonyldiazomethanes, triphenylsulfonium tris(trifluoromethylsulfonyl)methide, triphenylsulfonium bis(trifluoromethylsulfonyl)imide, diphenyliodonium tris(trifluoromethylsulfonyl)methide, diphenyliodonium bis(trifluoromethylsulfonyl)imide, N-hydroxynaphthalimide triflate, and their homologues are also possible candidates. FIG. 1(a) and 1(b) show some examples of photoactive compounds, where R₁—R₃ are independently (C₁-C₈)alkyl or (C₁-C₈)alkoxy substituents, X⁻ is a sulfonate counterion, n=1-20, and R is independently at least one chosen from (C₁-C₈)alkyl, (C₁-C₈)alkoxy, phenyl, styrylphenyl, (C₁-C₈)alkoxy-styrylphenyl, furylethylidene, (C₁-C₈)alkyl substituted furylethylidene, naphthyl, (C₁-C₈)alkyl and (C₁-C₈)alkoxy substituted naphthyl. Mixtures of photoactive compounds may also be used. The photoactive compound, preferably a photoacid generator, may be incorporated in a range from 0.1 weight % to 50 weight % by solids. It may also be added at levels ranging from 1 to 30 weight % by solids. In one embodiment the photoacid generator can range from about 3 to about 10 weight % by solids. Adjusting the ratio of polymer to photoacid generator allows control of the developed profile of the undercoating layer, where in some cases, a near vertical photoresist profile is desired.

The solvent for the undercoating is chosen such that it can dissolve all the solid components of the undercoating, and also can be removed during the bake step so that the resulting coating is not soluble in the coating solvent of the photoresist. Furthermore, to retain the integrity of the undercoating, the polymer of the undercoating is also not substantially soluble in the solvent of the top photoresist. Such requirements prevent, or minimize, intermixing of the undercoating layer with the photoresist layer. Typically propyleneglycolmonomethyl ether acetate and ethyl lactate are the preferred solvents for the top photoresist. Examples of suitable solvents for the undercoating composition are cyclohexanone, cyclopentanone, anisole, 2-heptanone, ethyl lactate, propylene glycol monomethyl ether acetate, propylene glycol monomethyl ether, butyl acetate, gamma butyroacetate, heptanone, ethyl cellosolve acetate, methyl cellosolve acetate, methyl 3-methoxypropionate, ethyl pyruvate, 2-methoxybutyl acetate, 2-methoxyethyl ether, diacetone alcohol and mixtures thereof. Solvents with a lower degree of toxicity and good coating and solubility properties are generally preferred.

Typical undercoating compositions of the present invention may comprise a solid content of up to about 0.5 to about 10 percent by weight of the solution in one case and in another case a solid content of up to about 0.5 to about 8 percent by weight of the solution.

The solid components are dissolved in the solvent, or mixtures of solvents, and filtered to remove impurities. The components of the undercoating may also be treated by techniques such as passing through an ion exchange column, filtration, and extraction process, to improve the quality of the product.

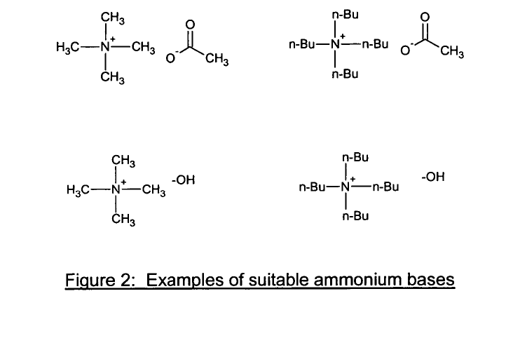

In addition to the polymer, photoacid generator and solvent, other components may be added to the undercoating composition, in order to enhance the performance of the coating, e.g. (C₁-C₅) alkylalcohols, dyes, surface leveling agents, adhesion promoters, antifoaming agents, etc. These additives may be present at up to 10 weight percent level. Other polymers, such as, novolaks, polyhydroxystyrene, polymethylmethacrylate, polymaleimdes, copolymers of maleimide, and polyarylates, may be added to the composition, providing the performance is not negatively impacted. The other polymers may be used to adjust the solubility of the coating in aqueous alkali developer and/or prevent solubility in the solvent of the photoresist. In an example, the amount of this polymer is kept below 30 weight % of the total solids of the composition. In another case the amount of this polymer is kept below 20 weight % of the total solids of the composition. In yet another case the amount of this polymer is kept below 10 weight % of the total solids of the composition. Bases may also be added to the composition to enhance stability. Both photobases and nonphotobases are known additives. Examples of bases are amines, ammonium hydroxide, and photosensitive bases. Particularly preferred bases are tetrabutylammonium hydroxide, triethanolamine, diethanol amine, trioctylamine, n-octylamine, trimethylsulfonium hydroxide, triphenylsulfonium hydroxide, bis(t-butylphenyl)iodonium cyclamate and tris(tert-butylphenyl)sulfonium cyclamate. FIG. 2 describes some of the bases.

In one embodiment, useful for irradiation with 365 nm exposure source, a thin undercoating layer is formed over a metal surface, e.g. copper. A thick photoresist coating, greater than 20 microns, is coated over the undercoating layer. The undercoating layer serves to separate the photoresist from the metal substrate and the undercoating polymer is essentially nonabsorbing at the wavelength of exposure radiation, and has an absorption parameter (k) of less than 0.099 measured at 365 nm. The absorption parameter is measured using a J. A. Woollam VUV-VASE™ VU-302 Ellipsometer (available from J. A. Woollam Co. Inc, Lincoln, Nebr.).

In one embodiment the undercoating composition has an absorption parameter (k) of less than 0.099 measured at the exposure wavelength(s) of the photoresist coated over the undercoating layer. Thus the undercoating is minimally absorbing at the exposure wavelength of the photoresist. The refractive index can range from about 1.4 to about 2.1. The absorption parameter (k) and the refractive index (n) are measured using a J. A. Woollam VUV-VASE™ VU-302 Ellipsometer (available from J. A. Woollam Co. Inc, Lincoln, Nebr.).

The photoresist that is used to form a layer above the undercoating layer is a light-sensitive photoresist composition useful for imaging thick films, comprising a polymer which is insoluble in an aqueous alkali developer but becomes soluble prior to development, and a photoacid generator which produces a strong acid upon irradiation. The polymer of the photoresist composition of the present invention is insoluble in an aqueous alkali developer but becomes soluble prior to development. Typically the polymer is an aqueous alkali soluble polymer which is protected by at least one acid labile group. Alkali soluble polymers can be homopolymers or copolymers comprising at least one unit derived from monomers comprising an acidic hydroxy group or an ester group. An example of the alkali soluble polymer is a polymer comprising at least one unit with a phenolic group, such as comprising the unit derived from a hydroxystyrene monomer. The phenolic groups are blocked with an acid labile group, such as those described previously. Examples are esters and/or acetals, tert-butoxycarbonyl or alkyloxycarbonylalkyl (such as (tert-butoxycarbonyl)methyl). Also preferred are (alkyl)acrylates which may be copolymerized to provide an acid labile ester group, examples of which are tert-butyl acrylate, tert-butyl methacrylate and methyladamantyl acrylate. Polymers comprising units derived from hydroxystyrene are useful for photoresists for 365 nm or broadband exposure radiation. Broadband radiation is usually referred to exposure sources using long wavelengths of ultraviolet radiation, typically 436 nm to 300 nm. Copolymers of hydroxystyrene and acrylates can be used. The polymers may further comprise comonomeric units which do not have acid labile groups and are derived from polymerizable monomers, for example, styrene, acetoxystyrene, and methoxystyrene.

Examples of hydroxystyrene based resins usable for capping with acid labile groups include: poly-(4-hydroxystyrene); poly-(3-hydroxystyrene); poly-(2-hydroxystyrene); and copolymers of 4-, 3-, or 2-hydroxystyrene with other monomers, particularly bipolymers and terpolymers. Examples of other monomers usable herein either as homopolymers or copolymers include 4-, 3-, or 2-acetoxystyrene, 4-, 3-, or 2-alkoxystyrene, styrene, α-methylstyrene, 4-, 3-, or 2-alkylstyrene, 3-alkyl-4-hydroxystyrene, 3,5-dialkyl-4-hydroxystyrene, 4-, 3-, or 2-chlorostyrene, 3-chloro-4-hydroxystyrene, 3,5-dichloro-4-hydroxystyrene, 3-bromo-4-hydroxystyrene, 3,5-dibromo-4-hydroxystyrene, isopropenylphenol, propenylphenol, vinylbenzyl chloride, 2-vinylnaphthalene, vinylanthracene, vinylaniline, vinylbenzoic acid, vinylbenzoic acid esters, N-vinylpyrrolidone, 1-vinylimidazole, 4-, or 2-vinylpyridine, 1-vinyl-2-pyrrolidinone, N-vinyl lactam, 9-vinylcarbazole, vinyl benzoate, acrylic acid and its derivatives, i.e. methyl acrylate and its derivatives, acrylamide and its derivatives, methacrylic acid and its derivatives, i.e. methyl methacrylate and its derivatives, methacrylamide and its derivatives, N-(4-hydroxyphenyl)(meth)acrylamide, N-(3-hydroxyphenyl)(meth)acrylamide, N-(2-hydroxyphenyl)(meth)acrylamide, N-(4-hydroxybenzyl)(meth)acrylamide, N-(3-hydroxybenzyl)(meth)acrylamide, N-(2-hydroxybenzyl)(meth)acrylamide, 3-(2-hydroxy-hexafluoropropyl-2)-styrene, and 4-(2-hydroxy-hexafluoropropyl-2)-styrene, acrylonitrile, methacrylonitrile, 4-vinyl benzoic acid and its derivatives, i.e. 4-vinyl benzoic acid esters, 4-vinylphenoxy acetic acid and its derivatives, i.e. 4-vinylphenoxy acetic acid esters, maleimide and its derivatives, N-hydroxymaleimide and its derivatives, maleic anhydride, maleic/fumaric acid and their derivatives, i.e. maleic/fumaric acid ester, vinyltrimethylsilane, vinyltrimethoxysilane, or vinyl-norbornene and its derivatives. Examples of polymers usable herein include, poly-(4-hydroxyphenyl)(meth)acrylate, poly-(3-hydroxyphenyl)(meth)acrylate, poly-(2-hydroxyphenyl)(meth)acrylate,

The photoresist comprises the polymer and a photoacid generator. The typical photoacid generators are described previously and those that are useful for the underlayer coating may also be used for the photoresist. The photoacid generator(s) may be the same for both layers or different.

The photoresist may additionally contain other components, such as a photobleachable dye and/or a base additive. The photobleachable dye preferably is one which is absorbing at the same radiation as the photoacid generator and more preferably has a similar or lower rate of photobleaching. Preferably the bleachable dye is a diazonaphthoquinone sulfonate ester of a polyhydroxy compound or monohydroxy phenolic compound, which can be prepared by esterification of 1,2-napthoquinonediazide-5-sulfonyl chloride and/or 1,2-naphthoquinonediazide-4-sulfonyl chloride with a phenolic compound or a polyhydroxy compound having 2-7 phenolic moieties, and in the presence of basic catalyst. Diazonaphthoquinones as photoactive compounds and their synthesis are well known to the skilled artisan. These compounds, which comprise a component of the present invention, are preferably substituted diazonaphthoquinone dyes, which are conventionally used in the art in positive photoresist formulations. Such sensitizing compounds are disclosed, for example, in U.S. Pat. Nos. 2,797,213, 3,106,465, 3,148,983, 3,130,047, 3,201,329, 3,785,825 and 3,802,885. Useful photobleachable dyes include, but are not limited to, the sulfonic acid esters made by condensing phenolic compounds such as hydroxy benzophenones, oligomeric phenols, phenols and their derivatives, novolaks and multisubstituted-multihydroxyphenyl alkanes with naphthoquinone-(1,2)-diazide-5-sulfonyl chloride and/or naphtho-quinone-(1,2)-diazide-4-sulfonyl chlorides. In one embodiment of the bleachable dye, monohydroxy phenols such as cumylphenol are used. In another embodiment of the bleachable dye, the number of the phenolic moieties per one molecule of the polyhydroxy compound used as a backbone of bleachable dye is in the range of 2-7, and more preferably in the range of 3-5. Thick photoresist film are further described in the U.S. patent application with Ser. No. 11/179,364 filed Jul. 12, 2005, and incorporated herein by reference.

Typical photoresist useful for imaging at the wavelength(s) ranging from about 450 nm to about 150 nm may be used, such as photoresists for 365 nm, broadband, 248 nm, 193 nm and 157 nm.

In some cases bases or photoactive bases are added to the photoresist to control the profiles of the imaged photoresist and prevent surface inhibition effects, such as T-tops, where the top of the photoresist image is wider than the underlying photoresist image to by forming a T-shape. Bases may be added at levels from about 0.01 weight % to about 5 weight % of solids, preferably up to 1 weight % of solids, and more preferably to 0.07 weight % of solids. Nitrogen containing bases are preferred, specific examples of which are amines, such as triethylamine, triethanolamine, aniline, ethylenediamine, pyridine, tetraalkylammonium hydroxide or its salts. Examples of photosensitive bases are diphenyliodonium hydroxide, dialkyliodonium hydroxide, trialkylsulfonium hydroxide, etc. The base may be added at levels up to 100 mole % relative to the photoacid generator. Although, the term base additive is employed, other mechanisms for removal of acid are possible, for instance by using tetraalkylammonium salts of volatile acids (eg. CF₃CO₂⁻) or nucleophilic acids (eg Br⁻), which respectively remove acid by volatilization out of the film during post-exposure bake or by reaction of a nucleophilic moiety with the acid precursor carbocation (e.g. reaction of tert-butyl carbocation with bromide to form t-butylbromide).

FIG. 2 shows the structures of ammonium derivatives which might be employed as bases.

The use of non volatile amine additives is also possible. Preferred amines would be ones having a sterically hindered structure so as to hinder nucleophilic reactivity while maintaining basicity, low volatility and solubility in the resist formulation, such as a proton sponge, 1,5-diazabicyclo[4.3.0]-5-nonene, 1,8-diazabicyclo[5,4,0]-7-undecene, cyclic akylamines, or polyether bearing amines such as described in U.S. Pat. No. 6,274,286.

The photoresist of the present invention may contain other components such as additives, surfactants, dyes, plasticizers, and other secondary polymers. Surfactants are typically compounds/polymers containing fluorine or silicon compounds which can assist in forming good uniform photoresist coatings. Certain types of dyes may be used to provide absorption of unwanted light. Plasticizers may be used, especially for thick films, to assist in flow properties of the film, such as those containing sulfur or oxygen. Examples of plastisizers are adipates, sebacates and phthalates. Surfactants and/or plasticizers may be added at concentrations ranging from 0.1 to about 10 weight % by total weight of solids in the photoresist composition. Secondary polymers may be added to the composition of the present invention, especially preferred are novolak resins, which can be prepared from polymerization of phenol, cresols, di- and trimethy-substituted-phenols, polyhydroxybenzenes, naphthols, polyhydroxynaphthols and other alkyl-substituted-polyhydroxyphenols and formaldehyde, acetaldehyde or benzaldehyde. Secondary polymers may be added at levels ranging from about 0% to about 70% of total solids, preferably from about 5% to about 60% of total solids preferably from about 10% to about 40% of total solids.

In producing the photoresist composition, the solid components of the photoresist are mixed with a solvent or mixtures of solvents that dissolve the solid components of the photoresist. Suitable solvents for photoresists may include, for example, a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate; a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or heptanone (2-heptanone); a ketone ether derivative such as diacetone alcohol methyl ether; a ketone alcohol derivative such as acetol or diacetone alcohol; lactones such as butyrolactone; an amide derivative such as dimethylacetamide or dimethylformamide, anisole, and mixtures thereof.

As described above, for the photoresist useful for the present invention, the hydroxystyrene based resin is made alkali insoluble by protecting alkali soluble groups on the resin with an acid cleavable protective group. The introduction of the protective group may be carried out by any proper method depending upon alkali soluble groups on the resin, and could be easily carried out by a person having ordinary skill in the art.

For example, when the alkali soluble group on the resin is a phenolic hydroxy group, the phenolic hydroxy groups present in the resin are partly or fully protected by any known acid labile protective group, preferably by one or more protective groups which form acid cleavable C(O) OC, C—O—C or C—O—Si bonds. Examples of protective groups usable herein include acetal or ketal groups formed from alkyl or cycloalkyl vinyl ethers, silyl ethers formed from suitable trimethylsilyl or t-butyl(dimethyl)silyl precursors, alkyl ethers formed from methoxymethyl, methoxyethoxymethyl, cyclopropylmethyl, cyclohexyl, t-butyl, amyl, 4-methoxybenzyl, o-nitrobenzyl, or 9-anthrylmethyl precursors, t-butyl carbonates formed from t-butoxycarbonyl precursors, and carboxylates formed from t-butyl acetate precursors. Also useful are groups such as (tert-butoxycarbonyl)methyl and its (C₁-C₆) alkyl analogs.

When the alkali soluble group on the resin is a carboxyl group, the carboxyl groups present on the resin are partly or fully protected by an acid labile protective group, preferably by one or more protective groups which form acid cleavable C—O—C or C—O—Si bonds. Examples of protective groups usable herein include alkyl or cycloalkyl vinyl ethers and esters formed from precursors containing methyl, methyloxymethyl, methoxyethoxymethyl, benzyloxymethyl, phenacyl, N-phthalimidomethyl, methylthiomethyl, t-butyl, amyl, cyclopentyl, 1-methylcyclopentyl, cyclohexyl, 1-methylcyclohexyl, 2-oxocyclohexyl, mevalonyl, diphenylmethyl, α-methylbenzyl, o-nitrobenzyl, p-methoxybenzyl, 2,6-dimethoxybenzyl, piperonyl, anthrylmethyl, triphenylmethyl, 2-methyladamantyl, tetrahydropyranyl, tetrahydrofuranyl, 2-alkyl-1,3-oxazolinyl, trimethylsilyl, or t-butyldimethylsilyl group.

Polymers comprising units derived from at least one monomer selected from substituted hydroxystyrene, unsubstituted hydroxystyrene, substituted alkyl(meth)acrylates, unsubstituted (meth)acrylates can be used. The (meth)acrylates may contain acid labile groups or nonacid labile groups. Examples of acid labile (meth)acrylates are tert-butyl acrylate, tert-butyl methacrylate and methyladamantyl acrylate The polymer may further comprise units which do not have an acid labile group, such as those derived from monomers based on substituted or unsubstituted styrene, ethylene with pendant groups such as cyclo(C₅-C₁₀)alky, adamantly, phenyl, carboxylic acid, etc.

The alkali insoluble polymer of the photoresist has a weight average molecular weight ranging from about 2,000 to about 100,000, preferably from about 3,000 to about 50,000, and more preferably from about 5,000 to about 30,000. The polymer is present in the formulation at levels ranging from about 20 to about 99 weight %, preferably from about 85 to about 98 weight % by total solids of the photoresist.

The prepared undercoating composition solution can be applied to a substrate by any conventional method used in the lithographic art, including dipping, spraying, whirling and spin coating. When spin coating, for example, the solution can be adjusted with respect to the percentage of solids content, in order to provide coating of the desired thickness, given the type of spinning equipment utilized and the amount of time allowed for the spinning process. Suitable substrates include, without limitation, silicon, silicon substrate coated with a metal surface, copper coated silicon wafer, copper, aluminum, polymeric resins, silicon dioxide, metals, doped silicon dioxide, silicon nitride, tantalum, polysilicon, ceramics, aluminum/copper mixtures; gallium arsenide and other such Group III/V compounds.

The underlayer coating composition produced by the described procedure are particularly suitable for application to copper coated substrates, such as are utilized in the production of microprocessors and other miniaturized integrated circuit components. The substrate may have an adhesion promoted layer of a suitable composition, such as one containing hexa-alkyl disilazane.

The undercoating composition solution is coated onto the substrate, and heated to substantially remove the solvent. The heating may be done on a hotplate at a temperature from about 50° C. to about 120° C. for about 30 seconds to 5 minutes, or in a convention oven at a temperature from about 50° C. to about 120° C. for about 15 minutes to about 90 minutes.

The photoresist composition solution is then coated onto the undercoating film, and the substrate is treated at a temperature from about 70° C. to about 150° C. for from about 30 seconds to about 6 minutes on a hot plate or for from about 15 to about 90 minutes in a convection oven. This temperature treatment is selected in order to reduce the concentration of residual solvents in the photoresist, while not causing substantial thermal degradation of the photoabsorbing compounds. In general, one desires to minimize the concentration of solvents and this first temperature treatment is conducted until substantially all of the solvents have evaporated and a coating of photoresist composition, on the order of 2-200 microns (micrometer) in thickness, remains on the substrate. Multiple coatings may be done to achieve thick photoresist films, such as multiple steps of coating and baking the photoresist to produce the final film thickness. In one embodiment the temperature is from about 95° C. to about 135° C. The temperature and time selection depends on the photoresist properties desired by the user, as well as the equipment used and commercially desired coating times. The coated substrate can then be exposed to actinic radiation, e.g., ultraviolet radiation, at a wavelength of from about 300 nm (nanometers) to about 450 nm, deep ultraviolet (250-100 nm) x-ray, electron beam, ion beam or laser radiation, in any desired pattern, produced by use of suitable masks, negatives, stencils, templates, etc. Generally, thick photoresist films are exposed using 436 nm and 365 nm Stepper Exposure Equipment; broadband radiation, using equipments such as Ultratech, Karl Süss or Perkin Elmer broadband exposure tools. Typically, the broadband exposure equipments have radiation ranging anywhere from 450 nm to 300 nm. Exposure steppers using 193 nm and 157 nm radiation may also be used.

The substrate with the coated films is then subjected to a post exposure second baking or heat treatment either before or after development. The heating temperatures may range from about 90° C. to about 150° C., more preferably from about 90° C. to about 130° C. The heating may be conducted for from about 30 seconds to about 3 minutes, more preferably from about 60 seconds to about 2 minutes on a hot plate or about 30 to about 45 minutes by convection oven.

The exposed undercoating/photoresist-coated substrate is developed to remove the image-wise exposed areas by immersion in a developing solution or developed by spray or puddle development process. The solution may agitated, for example, by nitrogen burst agitation, or use any method of development known to achieve the development function. The substrates are allowed to remain in the developer until all, or substantially all, of the photoresist coating has dissolved from the exposed areas. Developers include aqueous solutions of ammonium or alkali metal hydroxides. One developer solution comprises tetramethyl ammonium hydroxide. Other developers may comprise sodium or potassium hydroxide. Additives, such as surfactants, may be added to the developer. After removal of the coated wafers from the developing solution, one may conduct an optional post-development heat treatment or bake to increase the coating's adhesion and density of the photoresist. The imaged substrate may then be coated with metals, or layers of metals to form bumps as is well known in the art, or processed further as desired.

Unless otherwise indicated, all numbers expressing quantities of ingredients, properties such as molecular weight, reaction conditions, and so forth used in the specification and claims are to be understood as being modified in all instances by the term “about.” Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

The wafers used for the lithographic examples were silicon wafers or copper coated silicon wafers. The copper coated silicon wafers were silicon wafers coated with 5,000 Angstroms of silicon dioxide, 250 Angstroms of tantalum nitride, and 3,500 Angstroms of Cu(PVD deposited).

### Synthesis of Undercoating Polymer

### Example 1

To a 500 ml, 4 neck flask equipped with a condenser, thermometer, nitrogen gas inlet, and a mechanical stirrer were added benzyl methacrylate (17.3 g), methacrylate ester of mevalonic lactone (MLMA) (36 g), and tetrahydrofuran (THF) (50 g). Azoisobutylnitrile (AlBN) (8 g) and tetrahydrofuran (THF) (83 g) were mixed separately. The reaction was degassed for 10 minutes with stirring. The reaction was heated to reflux and then the AlBN solution was added. The reaction was refluxed and stirred for 6 hours and then drowned into 1500 ml of hexane. The precipitated polymer was filtered and dried. The polymer was next dissolved in 180 g of acetone and then slowly added to 1800 ml of methanol to reprecipitate the polymer. The polymer was filtered, rinsed and dried. The reprecipitated polymer was redissolved in 120 g of acetone and then precipitated again into 1200 ml of methanol. The product was filtered and dried. The molecular weight of the dried polymer by gel permeation chromatography (GPC) was 10,700. NMR H₁ (d6 DMSO) analysis showed 33.4 mole % benzyl methacrylate in the finished polymer.

### Synthesis of Undercoating Polymer

### Example 2

To a 250 ml, 4 neck flask equipped with a condenser, a thermometer, nitrogen gas inlet and a mechanical stirrer, were added styrene (1.6 g), MLMA (18.4 g), AlBN (3 g) and THF (50 g). A solution was obtained and degassed for 10 minutes. The reaction was refluxed for 4.5 hours and then drowned into 600 ml of hexane. The precipitated polymer was filtered and dried. NMR H₁ (d6 DMSO) analysis showed 16 mole % styrene in the finished polymer, and the analysis gave the following peaks: C₆H₅ at 7.4, OCH₂ at 4.3, and C₆H₅CH₂ at 5.05.

### Synthesis of Undercoating Polymer

### Example 3

To a 250 ml, 4 neck flask equipped with a condenser, a thermometer, a nitrogen gas inlet and a mechanical stirrer, were added N-methyl maleimide (5 g), methacrylate ester of mevalonic lactone (MLMA) (26 g), methacrylate ester of methyladamantane (MADMA) (3 g), azoisobutylnitrile (AlBN) (5.2 g) and tetrahydrofuran (THF) (60 g). A solution was obtained and degassed for 10 minutes. The reaction was refluxed for 4 hours and then drowned into 600 ml of hexane. The precipitated polymer was filtered and dried. The polymer gave at 193 nm a k value of 0.04 and n value of 1.69. This polymer is useful for all the exposure wavelengths where the absorption is minimal.

### Synthesis of Undercoating Polymer

### Example 4

To a 250 ml, 4 neck flask equipped with a condenser, a thermometer, a nitrogen gas inlet and a mechanical stirrer were added the methacrylate ester of 9-anthracene methanol (AMMA) (6.4 g), MLMA (8.6 g), AlBN (3 g) and cyclopentanone (40 g). A solution was obtained and degassed for 10 minutes. The reaction was refluxed for 4.5 hours and then drowned into 600 ml of hexane. The precipitated polymer was filtered and dried. The polymer gave at 248 nm a k value of 0.384 and a n value of 1.69. This polymer, although absorbing at 248 nm, is transparent at 365 nm and can used for 365 nm or broad band exposure.

### Example 1

### Undercoating Composition 1

2 g of an undercoating polymer from Synthesis Example 1 (65 mole % methacrylic ester of mevaloniclacetone (MLMA) and 35% benzylmethacrylate) and 0.15 g of N-trifluoromethylsulfonyloxy-1,8-naphthalimide (PAG) were dissolved in 213 g of 4-hydroxy-4-methyl-2-pentanone(diacetonealcohol (DAA)) and 0.164 g of APS-437 surfactant (available from D.H.Litter Co., 565, Taxter Rd., Elmsford, N.Y.) was added. The solution was mixed and micro-filtered through a 0.01 micron filter. The solids content of this solution was 0.998%. The k value (extinction coefficient) was 0.0074 at 365 nm and was measured using a J. A. Woollam VASE™ 302 ellipsometer.

Similarly, other undercoating compositions can be made according to Example 1 using polymers from Synthesis of Undercoating Polymer: Example 2-4 by mixing with the same PAG as in this example or other types of PAGs.

### Example 2

### Undercoating Composition 2

The solution prepared in Example 1 was diluted to 0.6995% solids, by adding 49.84 g of DAA solvent to 116.812 g of the undercoating solution as prepared in Example 1.

Similarly, other undercoating compositions can be made using polymers from Synthesis of Undercoating Polymer: Example 2-4 by mixing with the same PAG as in this example or other types of PAGs.

### Example 3

Photoresist A from Table 1 was applied on a silicon wafer, then coated to give 40 μm film thickness, and soft baked at 110° C. for 7 minutes on a hotplate using three variable proximity gaps. The photoresist was processed by exposure to i-line(365 nm) radiation, post exposure baked (PEB) at 100° C. for 30 seconds on a hotplate and developed with AZ®300-MIF developer (a teramethyl ammonium hydroxide aqueous solution available from AZ® Electronic Materials USA Corp, 70, Meister Avenue, Somerville, N.J.) for 5 minutes. The developed images were viewed using a scanning electron microscope and the results are given in Table 2.

### Example 4

Photoresist A from Table 1 was applied on a silicon wafer, then coated to give 40 μm film thickness, and soft baked at 110° C. for 7 minutes on a hotplate using three variable proximity gaps, to give 40 μm thick photoresist. The photoresist was processed by exposure to i-line(365 nm) radiation, post exposure baked (PEB) at 100° C. for 30 seconds on a hotplate and developed with AZ®300-MIF developer (available from AZ® Electronic Materials USA Corp, 70, Meister Avenue, Somerville, N.J.) for 5 minutes. The developed images were viewed using a scanning electron microscope and the results are given in Table 2.

### Example 5

The undercoating solution prepared in Example 1:Undercoating Composition 1, using the polymer from Synthesis Example 1, was coated on a copper coated silicon wafer and soft baked for 60 seconds at 110° C. The solution was spin coated at 5,800 rpm to produce 114 Angstroms thick film. The photoresist A from Table 1 was coated on top of the undercoating layer, to give 40 μm photoresist film, soft baked at 110° C. for 7 minutes on a hotplate using three variable proximity gaps. The photoresist and undercoating layers were processed by exposure to i-line radiation, post exposure baked (PEB) at 100° C. for 30 seconds on a hotplate and developed with AZ®300-MIF developer for 6 minutes. The developed images were viewed using a scanning electron microscope and the results are given in Table 2.

### Example 6

The Photoresist B from Table 1 was coated on a silicon wafer, to give a 100 μm film, by double coating using a first soft bake of 115° C. for 9 minutes and a second soft bake of 115° C. for 10 minutes with three variable proximity gaps on the hotplate. The photoresist was processed by exposure to i-line radiation, post exposure baked (PEB) at 100° C. for 35 seconds on a hotplate and developed with AZ®300-MIF developer for 6 minutes. The developed images were viewed using a scanning electron microscope and the results are given in Table 2.

### Example 7

The photoresist C was coated on a copper coated silicon wafer, to give 100 μm film, by double coating using two soft bakes of 110° C. for 7 minutes each and three variable proximity gaps. The photoresist was processed by exposure to i-line radiation, post exposure baked (PEB) at 100° C. for 30 seconds and developed with AZ®300-MIF developer for 8.5 minutes. The developed images were viewed using a scanning electron microscope and the results are given in Table 2.

### Example 8

The undercoating as prepared in Example 2:Undercoating Composition 1, using the polymer from Synthesis Example 1 was coated on copper coated silicon wafer and soft baked for 60 seconds at 110° C., by spin coating at 2,500 rpm to produce a 112 Angstroms film. The Photoresist C from Table 1 was coated on top of the undercoating film, to give a 100 μm photoresist film thickness by double coating using two soft bakes of 110° C. for 7 minutes each using three variable proximity gaps. The photoresist was processed by exposure to i-line radiation, post exposure baked (PEB) at 100° C. for 30 seconds and developed with AZ®300-MIF developer for 8.5 minutes. The developed images were viewed using a scanning electron microscope and the results are given in Table 2.

TABLE 1
Photoresist Compositions

| | | | | Bleachable | | | |
|---|---|---|---|---|---|---|---|
| | | | | Dye | | Solvents (g) | |
| | Polymer | | Base | (BD) | | PGMEA/ | |
| PR | (g) | PAG (g) | (g) | (g) | Plasticiser | cyclohexanone | % Solids |
| A | 18.8873 | 0.1548 | 0.024 | 0.2694 | 0.3049 | 18.319/ | 45.798 |
| | | | | | (L) | 4.5798 | |
| B | 24.5647 | 0.1739 | 0 | 0 | 1.306 | 19.164/ | 52.09 |
| | | | | | (PG) | 4.791 | |
| C | 22.666 | 0.1579 | 0 | 0 | 1.176 | 19.2/4.8 | 52.0 |
| | | | | | (PG) | | |

PR: Photoresist
Polymer: GIJ polymer is a ter-polymer of hydroxystyrene, styrene and tertiary-butylacrylate (available from Dupont Electronic Technologies, Ingleside, Texas.)
PAG: N-hydroxynaphthalimide triflate
BD: 80% ester of tetrahydroxybenzophenone with 2,1,5-diazonaphthoquinonesulfonylchloride
Base: triethanolamine
Plasticizer:
(L): Lutonal 40 (BASF AG, 67056 Ludwigshafen, Germany)
(PG): Polyglykol Bol/40 (Clariant Corp. 400, Monroe Rd. Charlotte, North Carolina)
Solvent: mixed PGMEA/cyclohexanone with up to 1 w % surfactant APS-437 (available from D.H. Litter Co., 565, Taxter Rd., Elmsford, New York) was added to the solution.

TABLE 2
Results

| | Example | | | | | |
|---|---|---|---|---|---|---|
| | 3 | 4 | 5 | 6 | 7 | 8 |
| Substrate | Si | Cu | Cu with | Si | Cu | Cu with |
| | | | UC | | | UC |
| Photospeed | 1,200 | 1,000 | 1,200 | 1,200 | 5,000 | 550-1,000 |
| mJ/cm² | | | | | | |
| Residue | clean | Occasional | clean | clean | No | clean |
| | | scum | | | clearing | |

UC: Undercoating Layer
Photospeed: Energy dose required to develop the exposed photoresist to give the same dimensions as the mask.

The results of the imaged substrates (Example 3-8) are given in Table 2, and showed that photoresist coated on copper coated silicon wafers with the undercoating layer gave clean images with reduced footing as compared to the photoresist coated directly on the copper coated silicon wafers. When the photoresist was coated directly on the copper coated silicon wafers residue was observed, even when fairly high exposure energy was used.

### Examples 9-13

New undercoating formulations were made according to Examples 9-13 in Table 3. Example 13 has a mixture of 2 polymers; a copolymer of methacrylic ester of mevalonic lactone and benzylmethacrylate and a copolymer of maleimide and acetoxystyrene. The undercoating Examples 9-13 were processed on copper coated silicon wafers. The undercoating solution was coated and soft baked at 110° C. for 60 seconds to give a film of 100 Angstroms. The photoresist A, was coated and baked at 110° C. for 3 minutes over the undercoating to give a thickness of 20 μm. The coatiings were exposed to i-line (365 nm) radiation and post exposure baked at 100° C. for 30 seconds. The wafers were then developed with AZ®300-MIF developer for 3 minutes. The imaged wafers were evaluated using scanning electron microscope. The results from the scanning electron microscope showed that all formulations gave uniform coatings, and clean and scum-free photoresist patterns. Additionally, the photoresist images from the copper coated wafers with an undercoating gave reduced footing for the photoresist patterns as compared to the ones with no undercoating.

TABLE 3

| Exam- | Polymer | PAG | PAG | Total | Solvent | % |
|---|---|---|---|---|---|---|
| ple | (g) | 1 (g) | 2 (g) | Solids (g) | (g) | Solids |
| 9 | 0.32395 | 0.09105 | 00 | 0.415 | 49.585 | 0.83 |
| 10 | 0.32463 | 0.05837 | 00 | 0.383 | 49.617 | 0.766 |
| 11 | 0.29796 | 00 | 0.05553 | 0.3535 | 49.6465 | 0.707 |
| 12 | 0.3232 | 0.22176 | 00 | 0.545 | 49.455 | 1.09 |
| 13 | 0.3025/ | 0.08474 | 00 | 0.45365 | 49.5463 | 0.9073 |
| | 0.066* | | | | | |

Polymer: Polymer of 65% methacrylic ester of mevaloniclacetone (MLMA) and 35% benzylmethacrylate
*Includes additional polymer: Polymer of 25% maleimide and 75% acetoxystyrene
PAG 1: N-trifluoromethylsulfonyloxy-1,8-naphthalimide
PAG 2: N-nonafluorobutanelsulfonyloxy-1,8-naphthalimide
Solvent: 4-hydroxy-4-methyl-2-pentanone (diacetonealcohol)
Surfactant: APS-437 added at 0.08% in solution to Examples 9-13.

### Example 14

Polymers 1-4: The solubility of polymer coatings with varying ratios of comonomers of poly(benzylmethacrylate-co-mevaloniclacetone) were tested in PGMEA solvent. The polymers were synthesized according to Synthesis Example 1, with varying amounts of the comonomers. The coatings were baked at 100° C. for 60 seconds, and placed in PGMEA for 15 seconds. The results are shown in Table 4. The polymer solubility in PGMEA increases as the content of benzylmethacrylate increases. It is desirable that the coating is essentially insoluble in the solvent of the photoresist, in this case, PGMEA, but the polymers can tested with other solvents also.

TABLE 4

| | | | Solubility in |
|---|---|---|---|
| Polymer | % MLMA | % benzylmethacrylate | PGMEA |
| 1 | 100 | 0 | insoluble |
| 2 | 65 | 35 | insoluble |
| 3 | 60 | 40 | very slightly soluble |
| | | | (less than 1% film |
| | | | loss) |
| 4 | >60% | <40% | complete film loss |

### Example 15

Polymer 1B: A co-polymer of MLMA(80 mole %) and anthracenemethacrylate (20 mole %) was tested for its solubility in PGMEA. This polymer was also insoluble in PGMEA. An undercoating composition can be made using this polymer and processed according to any one of Examples 1-13.

1. An undercoating composition for a photoresist comprising a polymer which is insoluble in an aqueous alkali developer but becomes soluble prior to development, and a photoacid generator which produces a strong acid upon exposure to radiation, and further where the polymer is transparent at the exposure radiation.

2. The undercoating composition of claim 1, where the polymer comprises at least one unit with an acid labile group.

3. The undercoating composition of claim 2, where the acid labile group is at least one group selected from as —(CO)O—R, —O—R, —O(CO)O—R, —C(CF₃)₂O—R, —C(CF₃)₂O(CO)O—R, —C(CF₃)₂(COOR), —O—CH₂—(CH₃)—OR, —O—(CH₂)₂—OR, —C(CF₃)₂—O—CH₂(CH₃)(OR), C(CF₃)—O—(CH₂)₂—OR, —O—CH₂(CO)—OR and —C(CF₃)—OC(CH₃)(CO)—OR, where R is at least one group selected from alkyl, cycloalkyl, substituted cycloalkyl, oxocyclohexyl, cyclic lactone, benzyl, silyl, alkyl silyl, substituted benzyl, alkoxy alkyl such as ethoxy ethyl or methoxy ethoxy ethyl, acetoxyalkoxy alkyl such as acetoxy ethoxy ethyl, tetrahydrofuranyl, menthyl, tetrahydropyranyl and mevalonic lactone.

4. The undercoating composition of claim 2, where the polymer further comprises a unit derived from an unsaturated monomer.

5. The undercoating composition of claim 1, where the undercoating composition forms a layer with a thickness in the range of about 5 nm to about 1 micron.

6. The undercoating composition of claim 1, where the photoresist forms a layer with a thickness in the range of about 2 microns to about 200 microns.

7. The undercoating composition of claim 1, where the exposure wavelength is in the range of about 440 nm to about 150 nm.

8. The undercoating composition of claim 1, where the exposure wavelength is selected from 436 nm, 365 nm, broadband ultraviolet radiation, 248 nm and 193 nm.

9. The undercoating composition of claim 1, where the undercoating composition forms a layer with a k value of less than 0.099.

10. The undercoating composition of claim 1, where the photoacid generator of the undercoating is selected from diazonium salts, iodonium salts and sulfonium salts, diazosulfonyl compounds, sulfonyloxy imides, nitrobenzyl sulfonate esters, and imidosulfonates.

11. The undercoating composition of claim 1, where the polymer is derived from at least one monomer selected from methacrylate ester of methyladamantane, methacrylate ester of mevalonic lactone, 3-hydroxy-1-adamantyl methacrylate, methacrylate ester of beta-hydroxy-gamma-butyrolactone, t-butyl norbornyl carboxylate, t-butyl methyl adamantyl methacryate, methyl adamantyl acrylate, t-butyl acrylate and t-butyl methacrylate; t-butoxy carbonyl oxy vinyl benzene, benzyl oxy carbonyl oxy vinyl benzene; ethoxy ethyl oxy vinyl benzene; trimethyl silyl ether of vinyl phenol, 2-tris(trimethylsilyl)silyl ethyl ester of methyl methacrylate.

12. A process for forming a positive image comprising:
a) providing a layer of an undercoating film of claim 1 on a substrate;
b) providing a coating of a top photoresist layer over the undercoating film;
c) imagewise exposing the photoresist layer and the undercoating film to radiation in a single step;
d) postexposure baking the substrate; and,
e) developing the photoresist layer and the undercoating layer with an aqueous alkaline developer.

13. The process of claim 12, where the undercoating film has a thickness of less than 25 nm.

14. The process of claim 12, where the k value of the undercoating film is less than 0.099.

15. The process of claim 12, where the photoresist layer comprises a chemically amplified photoresist.

16. The process of claim 12, where the photoresist comprises a polymer comprising at least one unit with an acid labile group and a photoacid generator capable of producing a strong acid.

17. The process of claim 12, where the photoresist layer has a thickness in the range of 2 microns to 200 microns.

18. The process of claim 12, where the undercoating film has a thickness of less than 25 nm and the photoresist layer has a thickness greater than 2 microns.

19. The process of claim 12, where the undercoating layer comprises a polymer which is insoluble in an aqueous alkali developer but becomes soluble prior to development, and a photoacid generator which produces a strong acid upon irradiation.

20. The process of claim 12, where the developer comprises tetramethyl ammonium hydroxide.
